(19) United States
(12) Patent Application Publication
(10) Pub. No.: US 2005/0158089 A1
(43) Pub. Date: Jul. 21, 2005

(54) Two stage fusing method and apparatus for high-speed full process color

(75) Inventor: Kiri B. Amarakoon, Pittsford, NY (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: Xerox Corporation

(21) Appl. No.: 10/758,344

(22) Filed: Jan. 15, 2004

(51) Int. Cl. G03G 15/20

(52) U.S. Cl. 399/341

(57) ABSTRACT

There is provided an image forming apparatus comprising a user interface for setting of image forming operation, a sheet feeder section including a plurality of sheet stacks and a sheet transport system, a first printing section including a first fusing assembly for partial fusing of toner images of four colors and robust fusing of toner images of black and white or highlight color and a duplexing assembly, and a second printing section including a second fusing assembly for robust fusing of toner images of four colors. The secondary printing section is connected and disposed at one of both sides of the first printing section, the sheet feeder section is connected and disposed at the other side, and the sections are used in an integrated state. The image forming apparatus further comprises a finishing section connected and disposed at one side of the secondary printing station and having an output portion.

### BACKGROUND

The present exemplary embodiment relates to an image forming apparatus using an electrostatographic system. It finds particular application in conjunction with a two stage fusing method and system for high-speed full process color printing and copying, and will be described with particular reference thereto. However, it is to be appreciated that the present exemplary embodiment is also amenable to other like applications.

In conventional electrostatographic printing machines, a charge retentive surface is charged to a uniform potential and exposed to a light source to selectively discharge the charge retentive surface to form a latent electrostatic image thereon. The image may be either the discharged portions or the charged portions of the charge retentive surface. The light source may be any well known device such as a light lens scanning system or a laser beam. Subsequently, the electrostatic latent image on the charge retentive surface is rendered visible by developing the image with developer powder referred to in the art as toner. The visible toner image is in a loose powdered form and can be easily disturbed or destroyed. The toner image is usually fed through a fusing apparatus where it is heated to permanently affix it to the copy sheet, thus forming a black and white copy of the original document.

For producing highlight color (HLC) images on documents, an extension is made to the base black and white print engine with the addition of one or two HLC marking stations. These can be thought of as multiple black and white marking elements except that the toner used has color pigments. The black and white image or the color image may be formed first on the photoconductive surface. The major difference between HLC and the full color processing described below is that there is only one layer of toner, and, therefore, there is no need for extra fusing.

Multi-color electrostatographic printing machines using multi-colored toners are substantially identical in each color image forming process to the foregoing process of black and white printing, which uses only black toner. However, rather than forming a single latent image on the photoconductive surface, several single color latent images corresponding to color separated light images of the original document are recorded thereon. Each single color electrostatic latent image is developed with toner particles of a complementary color. This process may be performed in a single pass or in multiple passes during which image formation is repeated a plurality of cycles for differently colored images using their respective complementarily colored toner particles to form color toner images. Each single color toner powder image is transferred to a copy sheet in superimposed registration with the other toner powder images.

This process creates a composite multi-layered toner powder image on the copy sheet. The copy sheet is separated from the photoconductive member and, thereafter, the multi-layered toner powder image on the sheet is fed through a fusing apparatus and permanently affixed to the copy sheet, thus creating a color copy of the original multi-color document. In a black and white or multi-color electrostatographic printing machine, the copy sheet is typically brought into moving contact with the photoconductive member during toner powder image transfer to the copy sheet. A sheet transport apparatus is typically provided for receiving the copy sheet incrementally as it is separated from the photoconductive member, and for transporting the copy sheet towards and into the fusing apparatus.

The use of thermal energy for fixing toner images onto a support member is well known. In order to fuse toner onto a support surface permanently by heat, it is necessary to elevate the temperature of the toner to a point at which the constituents of the toner coalesce and become tacky. This heating causes the toner to flow to some extent into the fibers or pores of the support member. Thereafter, as the toner cools, solidification of the toner causes it to be firmly bonded to the support.

Several approaches to thermal fusing of toner images have been described in the prior art. These methods include providing the application of heat and pressure substantially concurrently by various means: a roll pair maintained in pressure contact; a belt member in pressure contact with a roll; and the like. Heat may be applied by heating one or both of the rolls, plate members or belt members. The fusing of the toner particles takes place when the proper combination of heat, pressure and contact (or dwell) time are provided. The balancing of these parameters to bring about the fusing of the toner particles is well known in the art, and they can be adjusted to suit particular machines or process conditions. Conventional fusing members and fusing systems are disclosed in Visser et al., U.S. Pat. No. 5,674,621; Uehara et al., U.S. Pat. No. 5,345,300; Jacobs, U.S. Pat. No. 5,268,559; Moore et al., U.S. Pat. No. 5,103,263; Schlueter, Jr., U.S. Pat. No. 4,763,158; and Vince, U.S. Pat. No. 3,584,195.

Many xerographic machines have been designed to produce only black and white or highlight color copies. However, in order to produce full process color copies, certain modifications would be needed. Fusing four layers of toners requires sophisticated fusing. Various approaches have been employed to produce full color copies at high speed, including using one very large fuser, one fuser with two fuser roll-pressure roll assemblies side by side, or two smaller fusing stations within the main printing machine. However, there are problems with these two approaches. First, the costs of incorporating one large fuser along with heating may run quite high, and it is not always possible to fit such a large fuser or two smaller fusers within the main printing machine. Thus, there is a need for an apparatus and method for producing high speed full process color images while keeping costs down and maintaining the architectural and footprint integrity of the main printing platform, which is generally designed to print black and white and HLC images.

### BRIEF DESCRIPTION

In accordance with one aspect of the present exemplary embodiment, there is provided an image forming apparatus, which includes a user interface for setting of image forming operation, a sheet feeder section including a plurality of sheet stacks and a sheet transport system, a first printing section including a first fusing assembly for partial fusing of toner images of four colors and robust fusing of toner images of black and white or highlight color and a duplexing assembly, and a second printing section including a second fusing assembly for robust fusing of toner images of four colors. The secondary printing section is connected and disposed at one of both sides of the first printing section, the sheet feeder section is connected and disposed at the other side, and the sections are used in an integrated state. The image forming apparatus further comprises a finishing section connected and disposed at one side of the secondary printing station and having an output portion.

In accordance with another aspect of the present exemplary embodiment, there is provided a method of forming images on a sheet using an image forming apparatus, which has a first printing section and a second printing section. The method includes obtaining a toner image on the first side of the sheet. Where the toner image on the first side comprises a full color image, the image is partially fused to the first side with a first fusing assembly in the first printing section at a level sufficient to permit handling of the sheet within the apparatus, and where the toner image on the first side comprises a black and white or highlight color image, the image is fully fused to the first side with the first fusing assembly. In the case where duplexing mode has been selected, a toner image is obtained on the second side of the sheet. Where the toner image on the second side comprises a full color image, the image is partially fused to the first side with the first fusing assembly at a level sufficient to permit handling of the sheet within the apparatus, and where the toner image on the first side comprises a black and white or highlight color image, the image is fully fused to the first side with the first fusing assembly. Finally, where at least one toner image on the sheet comprises a full color image, the full color image is fully fused to the sheet with a second fusing assembly in the second printing section.

In accordance with yet another aspect of the present exemplary embodiment, there is provided an apparatus for receiving a partially fused image sheet from a xerographic printer. The apparatus includes a fuser assembly for final fusing of the partially fused image sheet, a release agent delivery system for applying a release agent material, and a gloss enhancing station disposed downstream of the second fusing assembly for selectively enhancing the gloss properties of an image.

### BRIEF DESCRIPTION OF THE DRAWINGS

FIG. 1 is a schematic view of a image creating apparatus;

FIG. 2 is a schematic elevation view of a xerographic printing station within the image creating apparatus;

FIG. 3 is a schematic elevation view of a belt fuser for robust fusing; and

FIG. 4 is a flow chart illustrating an exemplary method of two stage fusing for high speed full process color.

### DETAILED DESCRIPTION

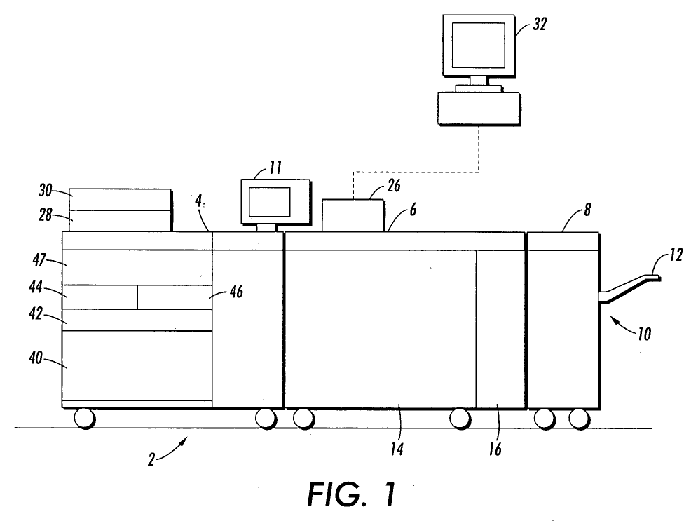

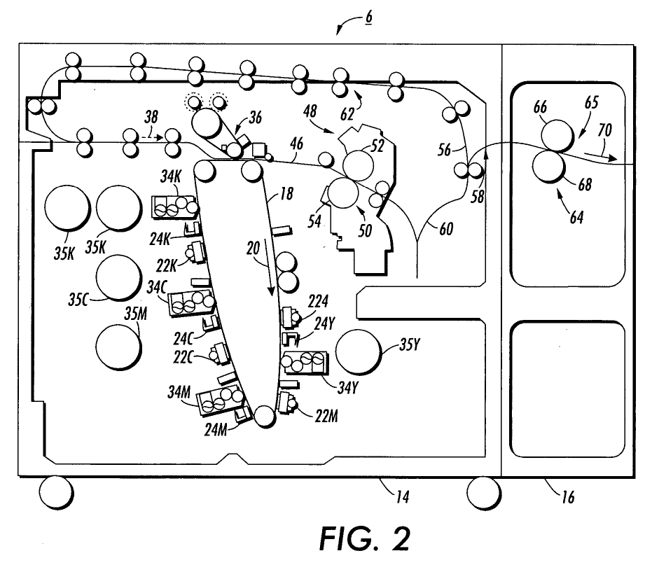

With reference to FIGS. 1 and 2, there is shown, in schematic form, a view of an image creating apparatus 2 for creating images in accordance with teachings of the present exemplary embodiment. Although the exemplary embodiment will be described with reference to the single embodiment shown in the drawings, it should be understood that many alternate forms of embodiments are contemplated. In addition, any suitable size, shape or type of elements or materials could be used. A copying or printing system of the type shown is preferably adapted to provide simplex or duplex stacked document sets from simplex or duplex collated document or print sets which result from either simplex or duplex original documents or output document computer files for print. The image creating apparatus 2, in the embodiment shown, is a copier. However, in an alternate embodiment, the apparatus could be a printer or any other suitable type of image creating apparatus.

The image creating apparatus 2 generally comprises a sheet feeder section 4, a xerographic processing or printing section 6, a finishing section 8 and an output section 10. A user interface 11 in which a display screen, an operation button, and a key for performing condition setting of image forming operation is also included. The printing section 6 typically incorporates an image transfer system and a transport system for transporting sheets of material. The finishing section 8 may typically incorporate a hole punch, a stapler, or any other suitable type of feature known in the art. The output section 10 incorporates at least one tray 12 that accepts and stacks documents or document sets output from the finishing section 8. Documents are printed or copied in the printing section 6 and output to the finishing section 8. Documents can be sorted and bound at the finishing section 8. Document sets can be output from the finishing section 8 at the output section 10 via the trays 12.

With reference to FIGS. 1 and 2, the printing section 6 preferably comprises two separate components, a primary printing station 14 and an independent secondary printing station 16. Preferably, the secondary printing station 16 is adjacent and external to the primary printing station 14. The secondary printing station 16 may be coupled to the primary printing station 14 by brackets or the like. The main printing station 14 can be an electrostatographic printing system such as those made by Xerox Corporation or, alternately, another xerographic or other type of printing apparatus. The main printing station 14 includes a photoconductive belt 18 that advances in the direction of arrow 20. The photoconductive belt 18 passes through four charging stations 22Y, 22M, 22C, and 22K and four exposure stations 24Y, 24M, 24C, and 24K for forming toner images of four colors of yellow (Y), magenta (M), cyan (C), and black (K). The exposure stations 24Y, 24M, 24C, and 24K are typically raster output scanners that transmit a latent image from the controller 26 onto the photoconductive surface of the photoconductive belt 18. The controller 26 gets the image from the input scanner 28, which typically scans an image from a document handler 30. In the alternative, the controller 26 gets the image from a separate computer 32 when the printing section 6 operates as a printing device. The photoconductive belt 18 then advances to four development stations 34Y, 34M, 34C, and 34K, where toner from storage units 35Y, 35M, 35C, and 35K is electrostatically attracted to the latent image. The photoconductive belt 18 then advances to an image transfer station 36. Meanwhile, a sheet of material 38 is advanced from one of the sheet stacks 40, 42, 44, or 46 by a sheet transport system 47, which includes a registration system (not shown). The sheet 38 is advanced past the image transfer station 36 in a timed fashion. The toner deposited on the latent image of photoconductive belt 18 is transferred to the sheet 38 due to the sheet 38 becoming charged at the image transfer station 36 and due to the sheet 38 being registered or timed relative to the latent image.

The sheet 38 is advanced to a first fusing station 48 by a belt 49, where the toner image is affixed to the sheet 38, typically by heating, thus creating a document sheet. The sheet 38 may be recirculated through the printing section to have a second (or duplex) image deposited on its opposite side.

The first fusing station 48 permanently affixes (or fuses) the transferred image to the sheet. Preferably, the first fusing station 48 comprises a roll fuser assembly 50, which includes a heated fuser roller 52 and a backup or pressure roller 54. The copy sheet 38 passes between the fuser roller 52 and the backup roller 54 with the toner powder image contacting the fuser roller 52. In this manner, the multi-color toner powder image is permanently affixed to the sheet. In the case of black and white images, the fusing of the image to the sheet is complete. That is, no further fusing is necessary. However, color images are only partially fused to the sheet. That is, the first fusing station 48 partially affixes the image to the sheet to a sufficient level so that the partially fused sheet can be transported around the duplex path. Thus, the first printing station 14 is generally limited to producing finished black and white or highlight color images or partially finished full color images. Such images may be produced at a rate of at least 120 to 180 pages per minute (ppm), although faster rates may be possible. In order to produce robust full process color images, the secondary printing station 16 is needed.

After fusing at the first fusing station 48, the chute 56 guides the advancing sheet 38 through the output 58 to the secondary printing station 16. However, for duplex operation, the sheet 38 is reversed in position at the inverter 60 and transported to the duplexing assembly 62. The sheet 38 receives an image on the second side thereof, at the transfer station 36, in the same manner as the image was deposited on the first side thereof. The completed duplex copy exits to the secondary printing station 16 via the output 58.

The secondary printing station 16 includes a secondary fusing station 64, which is shown as a roll fuser in FIG. 2. The secondary fusing station 64 generally comprises a roll fuser assembly 65, which includes a heated fuser roller 66 and a backup or pressure roller 68. In the case of full color copies, the partially fused copy sheet 38 passes between the fuser roller 66 and the backup roller 68 with the toner powder image contacting the fuser roller 66. In this manner, the fusing of the multi-color toner powder image to the sheet is completed. In the case of black and white (or highlight color) images, since the fusing of the image to the sheet has already been completed at the first fusing station, the rollers 66 and 68 do not engage the sheet 38. The sheet 38 then travels in the direction of arrow 70 to the finishing section 8. The image creating apparatus 2 may produce full process color images at a rate of at least 100 to 120 ppm, although faster speeds may be possible.

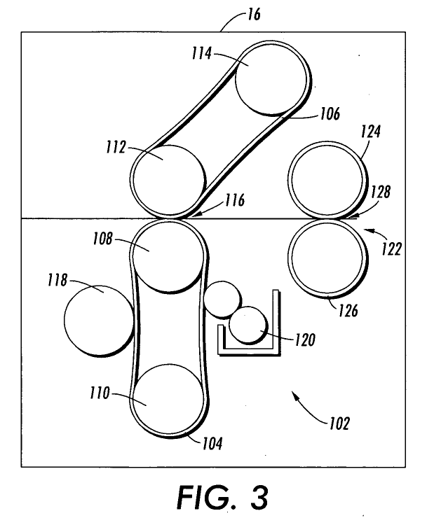

Attention is now directed to FIG. 3, wherein an alternative secondary fusing station 100, including a release agent management system, for use in the secondary printing station 16 is schematically illustrated. As shown in FIG. 3, the secondary fusing station 100 comprises a belt fuser assembly 102, which includes a heated fuser belt 104 and a pressure belt 106. The belts 104, 106 are endless belts, preferably flexible, which can be seamed or seamless. The belts 104, 106 are thin, having a thickness ranging for example from about 3 to about 20 mils, with a relatively smooth surface. A suitable degree of smoothness ensures the desired image gloss for fusing spot on spot color images as opposed to spot next to spot images.

The fuser belt 104 is entrained about a pair of rollers 108, 110 for movement in an endless path, while the pressure belt 106 is entrained about a pair of rollers 112, 114 for movement in an endless path. To this end, a motor and a drive mechanism (not shown) are provided for effecting movement of the belt in the clockwise direction as viewed in the FIG. 3.

The fuser belt 104 and the pressure belt 106 form a fusing nip 116 through which the sheet 38 carrying relatively thick toner images, with the toner images contacting the smooth surface of the belt member. A radiant heating assembly, which includes a roller 118, is provided for heating the belt in the nip.

A liquid release agent management or delivery system 120 may be provided for applying a release agent material such as silicone oil contained in a sump. The silicone oil is applied to the surface of the fuser belt 104. A thin film of the release agent on the fuser belt ensures that the toner image is completely released from the fuser belt during the fusing operation, thereby preventing the offset phenomenon. The liquid release agent may be selected from those materials which have been conventionally used. Typical release agents include a variety of conventionally used silicone oils including both functional and non-functional oils. Thus, the release agent is selected to be compatible with the rest of the system.

In the case of full color copies, the partially fused copy sheet 38 passes between the fuser belt 104 and the backup belt 106 with the toner powder image contacting the fuser belt 104. In this manner, the robust fusing of the multi-color toner powder image to the sheet is completed. In the case of black and white images, since the fusing of the image to the sheet has already been completed, the belts 104, 106 do not engage the sheet 38.

A gloss enhancing station 122 is preferably positioned downstream in the process direction for selectively enhancing the gloss properties of the sheet 38. The gloss enhancing station 122 has opposed fusing members 124, 126 defining a gloss nip 128 therebetween. The gloss nip 128 is adjustable to provide the selectability of the gloss enhancing. In particular, the fusing members are cammed whereby the transfuse nip is sufficiently large to allow a document to pass through without substantial contact with either fusing member 124, 126 that would cause glossing. When the operator selects gloss enhancement, the fusing members 124, 126 are cammed into pressure relation and driven to thereby enhancement the level of gloss on images passed through the gloss nip 128. The amount of gloss enhancement is operator selectable by adjustment of the temperature of the fusing members 124, 126. Higher temperatures of the fusing members 124, 126 will result in increased gloss enhancement. U.S. Pat. No. 5,521,688 (Hybrid Color Fuser) describes a gloss enhancing station with a radiant fuser.

The fusing members 124, 126 are preferably fusing rollers, but they can be fusing belts. The top-most surface of each fusing member 124, 126 is relatively non-conformable.

Although the apparatus 2 has been described in detail above, features of the present exemplary embodiment could be used with other types of xerographic processing or printing sections having any suitably blank paper or sheet supply, created document output, image transfer system or paper path. The description above is merely intended to be exemplary. More or less features could also be provided.

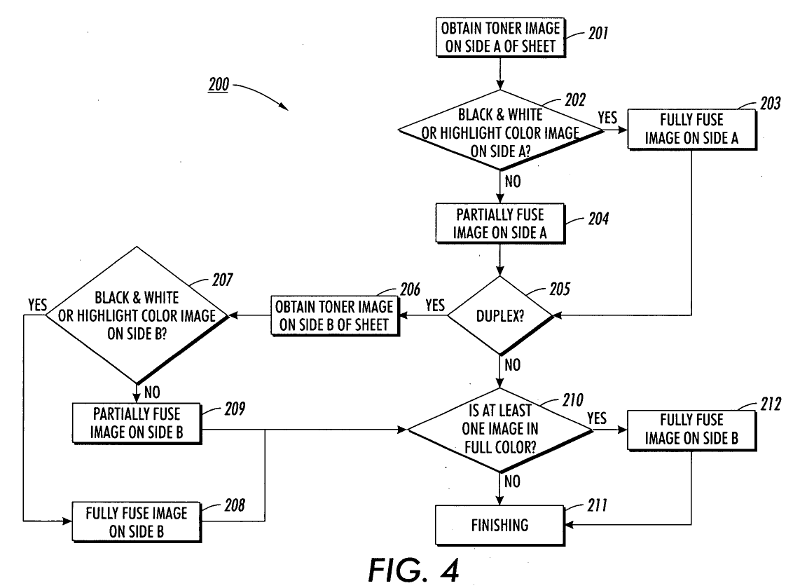

FIG. 4 is a flow chart illustrating an exemplary method 200 of two stage fusing for high speed full process color printing and copying. FIG. 4 is described below with reference to the apparatus 2 of FIGS. 1 and 2. It is to be understood that the method 200 may be implemented via software in the controller 26.

In the first step 201, a toner image is obtained on side A of the sheet 38 in the usual manner. Next, a determination is made as to whether the toner image on side A is a black and white or a highlight color image (step 202). If it is black and white or highlight color, then the image is permanently and fully fused to side A (step 203) in the usual manner. Otherwise, if the image is in full color, then the image is only partially fused to side A (step 204). That is, the image is fused to side A to a sufficient level such that the sheet 38 may be transported through the duplexing assembly 62 if necessary. There are various ways to test for the proper level. For instance, a “crease fix” test may be utilized. With the crease fix test, a large solid area of toner is transferred to the paper and fused. The paper is then folded so that the fold is in the middle of the solid area. When the paper is folded, the toner slab on the surface of the paper will crack and form a crease. The width of the line visible is a measure of the fix level. The narrower the line, the higher the fix level. It is to be understood that other tests may be used to set the appropriate partial fusing level. These other tests include the Abrader test, where an area of the fused image is abraded using a known pressure for a given number of rubs and observing the density change. Thus, at this point in the process, the sheet 38 contains either a fully or partially fused image on side A. Next, a determination is made as to whether the duplexing mode has been selected (step 205). If so, then a toner image is obtained on side B of the sheet 38 (step 206) in the usual manner. A determination is then made as to whether the toner image on side B is a black and white or HLC image (step 207). If it is black and white (or HLC), then the image is permanently and fully fixed or fused to side B in the usual manner (step 208). Otherwise, if the image is in full color, then the image is partially fused to side B as described above (step 209).

A determination is then made as to whether at least one image on the sheet 38 is in full color (step 210). If not, the sheet 38 proceeds through the secondary printing station 16 to the finishing section 8 (step 211). That is, the sheet 38 does not come into contact with the fusing assembly 65 or 102 of the secondary printing station 16. Otherwise, the sheet 38 is transported to the fusing assembly 65 or 102 secondary fusing station for full (or robust) fusing in the usual manner (step 212) before being transported to the finishing section 8 (step 212). Additionally, the gloss level of the image can be adjusted by using the gloss enhancing station 122 before finishing.

In summary, a smaller fuser such as that used for monochrome or HLC may be incorporated within the base architecture (or primary printing station) of a copying/printing platform. This primary fuser partially fuses a full color image on to the copy sheet to a level such that the sheet can be transported around the duplex path and registration elements. The sheet is then transported to a secondary fuser for completing the fusing process and to achieve the required level of gloss. The secondary fuser comprises an externally mounted larger roll fuser or a belt fuser. The gloss level can be selected by changing the characteristics of the secondary fuser. With the secondary fuser being an externally module, the architectural and footprint integrity of the platform is maintained.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An image forming apparatus, comprising:
a user interface for setting of image forming operation;
a sheet feeder section including a plurality of sheet stacks and a sheet transport system;
a first printing section including a first fusing assembly for partial fusing of toner images of four colors and robust fusing of toner images of black and white or highlight color and a duplexing assembly;
a second printing section including a second fusing assembly for robust fusing of toner images of four colors;
wherein the secondary printing section is connected and disposed at one of both sides of the first printing section, the sheet feeder section is connected and disposed at the other side, and the sections are used in an integrated state; and
a finishing section connected and disposed at one side of the secondary printing station and having an output portion.

2. The image forming apparatus defined in claim 1, wherein the first fusing assembly comprises a roll fuser.

3. The image forming apparatus defined in claim 1, wherein the first fusing assembly comprises a belt fuser.

4. The image forming apparatus defined in claim 1, wherein the second fusing assembly comprises a roll fuser.

5. The image forming apparatus defined in claim 1, wherein the first fusing assembly comprises a belt fuser.

6. The image forming apparatus defined in claim 1, wherein the second printing section includes a release agent delivery system for applying a release agent material.

7. The image forming apparatus defined in claim 1, wherein the second printing section includes a gloss enhancing station disposed downstream of the second fusing assembly for selectively enhancing the gloss properties of an image.

8. The image forming apparatus defined in claim 2, wherein the second fusing assembly comprises a roll fuser, and the second printing section includes a release agent delivery system for applying a release agent material and a gloss enhancing station disposed downstream of the second fusing assembly for selectively enhancing the gloss properties of an image.

9. The image forming apparatus defined in claim 2, wherein the second fusing assembly comprises a belt fuser, and the second printing section includes a release agent delivery system for applying a release agent material and a gloss enhancing station disposed downstream of the second fusing assembly for selectively enhancing the gloss properties of an image.

10. The image forming apparatus defined in claim 3, wherein the second fusing assembly comprises a roll fuser, and the second printing section includes a release agent delivery system for applying a release agent material and a gloss enhancing station disposed downstream of the second fusing assembly for selectively enhancing the gloss properties of an image.

11. The image forming apparatus defined in claim 2, wherein the second fusing assembly comprises a belt fuser, and the second printing section includes a release agent delivery system for applying a release agent material and a gloss enhancing station disposed downstream of the second fusing assembly for selectively enhancing the gloss properties of an image.

12. A method of forming images on a sheet using an image forming apparatus having a first printing section and a second printing section, the method comprising:
obtaining a toner image on the first side of the sheet;
where the toner image on the first side comprises a full color image, partially fusing the image to the first side with a first fusing assembly in the first printing section at a level sufficient to permit handling of the sheet within the apparatus;
where the toner image on the first side comprises a black and white or highlight color image, fully fusing the image to the first side with the first fusing assembly;
where duplexing mode has been selected, obtaining a toner image on the second side of the sheet;
where the toner image on the second side comprises a full color image, partially fusing the image to the first side with the first fusing assembly at a level sufficient to permit handling of the sheet within the apparatus;
where the toner image on the first side comprises a black and white or highlight color image, fully fusing the image to the first side with the first fusing assembly; and
where at least one toner image on the sheet comprises a full color image, fully fusing the full color image or images to the sheet with a second fusing assembly in the second printing section.

13. The image forming method defined in claim 12, wherein the first fusing assembly comprises a roll fuser.

14. The image forming method defined in claim 12, wherein the first fusing assembly comprises a belt fuser.

15. The image forming method defined in claim 12, wherein the second fusing assembly comprises a roll fuser.

16. The image forming method defined in claim 12, wherein the first fusing assembly comprises a belt fuser.

17. An apparatus for receiving a partially fused image sheet from an xerographic printer, comprising:
a fuser assembly for final fusing of the partially fused image sheet;
a release agent delivery system for applying a release agent material; and
a gloss enhancing station disposed downstream of the second fusing assembly for selectively enhancing the gloss properties of an image.

18. The apparatus defined in claim 10, wherein the fuser assembly comprises a roll fuser.

19. The apparatus defined in claim 10, wherein the fuser assembly comprises a belt fuser.
